(19) United States
(12) Patent Application Publication
(10) Pub. No.: US 2021/0403830 A1
(43) Pub. Date: Dec. 30, 2021

(54) JASMOL

(71) Applicant: SYMRISE AG, Holzminden (DE)

(72) Inventors: Manuel PESARO, Holzminden (DE); Jessica GRIEGER, Polle (DE); Beate DIESING, Uslar (DE); Celina PETERS, Bad Pyrmont (DE); Nicole SCHULZE, Freden (Leine) (DE); Anja FINKE, Holzminden (DE)

(21) Appl. No.: 17/294,803

(22) PCT Filed: Nov. 19, 2018
(86) PCT No.: PCT/EP2018/081797

§ 371 Date: May 18, 2021

(51) Int. Cl. C11D 3/00; C11D 3/48; C11D 3/20; C11D 3/24; C11D 11/00

(52) U.S. Cl. CPC C11D 3/0068; C11D 3/48; C11D 11/0017; C11D 3/2093; C11D 3/24; C11D 3/2034

(57) ABSTRACT

The present invention relates to a composition for reducing malodor, preferably a musty and/or mouldy malodor, methods for producing such a composition and the use of such a composition. Furthermore, the present invention relates to preparations containing such a composition, methods for producing such preparations and their use. The composition comprises the combination of 2-benzylheptanol (jasmol) with a compound selected from (I) 3,5-di-ter-butyl-4-hydroxytoluol (BHT), (II) octadecyl di-ter-butyl-4-hydroxy-hydrocinnamate (Tinogard TS) and (III) pentaerythrityl tetra-di-ter-butyl hydroxyhydrocinnamate (Tinogard TT).

The present invention relates to a composition comprising 2-benzylheptanol (Jasmol, CAS 92368-90-6) for reducing malodor, preferably a musty and/or mouldy malodor, methods for producing such a composition and the use of such a composition. Furthermore, the present invention relates to preparations containing such a composition, methods for producing such preparations and their use.

Washing and cleaning of clothes and laundry plays an important role for daily hygiene and wellbeing. Typically, a fresh, neutral and clean odor of the clothes/laundry after the washing or cleaning process is expected. Under certain conditions of daily life, the cleaned/washed clothes/laundry showed a musty, mouldy malodor after being washed or cleaned. This musty, mouldy malodor can also be described as cellar-like or like a wet, used floor cleaning cloth. It can be formed by slowly drying of the clothes/laundry under high humidity or when the wet clothes/laundry remains in the washing machine after the washing for some time.

Such musty, mouldy malodor has different causes. Microorganisms in the washing machine or on the fabric may metabolize remaining ingredients of the cleaning/washing liquor after cleaning/washing and form odor active compounds. Further odor actives can be formed by chemical or enzymatic degradation processes. Such odor actives usually provide the musty, mouldy malodor remaining on the clothes/laundry.

In the state of the art, a possibility to prevent the formation of this malodor is to use cleaning/washing temperatures of higher than 60° C. and washing detergents with oxidizing agents and/or higher amounts of strong antimicrobial active compounds, like Triclosan, cationic surfactants or silver salts. However, not all of the clothes/laundry is suited to be washed at such high temperatures. Furthermore, the use of antimicrobials is highly discussed because of their biodegradability and as they trigger the formation and enrichment of multi-resistant microorganisms in the washing machine or on the clothes/laundry. As the clothes/laundry will subsequently be in contact with human skin, typically for a long time, the use of antimicrobials in cleaning/washing of clothes/laundry, especially when risking the formation and enrichment of multi-resistant microorganisms, needs to be carefully considered.

There is thus still a need for compositions reducing such malodor, which can be used at lower washing temperature and without strong antimicrobials, such as Triclosan, cationic surfactants or silver salts. Additionally, the compositions need to be mainly active on the clothes/laundry and in the washing machine, instead of applying its effect on e.g. only the cleaning/washing liquor while being stored.

Compounds like Jasmol (2-benzylheptanol, CAS 92368-90-6) are used as antimicrobial active substance in cosmetic products, e.g. deodorants, antiperspirants (EP 1738803 A1) or as aromatic substance in perfume oils (Scognamiglio et al., Fragrance material review on 2-benzylheptanol, Food and Chemical Toxicology (2012), 50(Suppl. 2), S256-S258 CODEN: FCTOD7; ISSN: 0278-6915).

In the state of the art, BHT (3,5-Di-tert-butyl-4-hydroxytoluol, CAS 128-37-0) is used as antioxidant in cosmetic products or products for household, perfumery, food etc.

However, the products used in the state of the art are typically designed to almost completely remove microorganism from the clothes/laundry and/or also from the washing machine. Therefore, high concentrations of the included substances (i.e. antimicrobial active compounds like Triclosan, cationic surfactants or silver salts) are required. Such sub-stances/compositions will most likely cause the problems described above.

Therefore, a composition with much lower concentrations or without the use of such strong antimicrobial active compounds is required.

The object of the present invention was therefore to provide a composition for reducing malodor which is active on the clothes/laundry and/or in the washing machine and which contains only a low concentration or none of such strong antimicrobial active compounds.

The object described above is solved by a composition according to the invention for reducing malodor, preferably a musty and/or mouldy malodor, preferably of fabric, clothes and/or laundry, comprising or consisting of
(a) one or more compound(s) of formula (I) (2-Benzylheptanol)

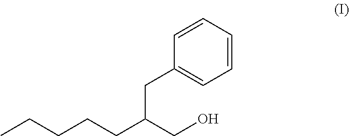

and
(b) one or more compound(s) selected from the group consisting of compound(s) of formula (II) (3,5-di-tert-butyl-4-hydroxytoluol, BHT), compound(s) of formula (III) (Octadecyl di-tert-butyl-4-hydroxy-hydrocinnamate, Tinogard TS) and compound(s) of formula (IV) (Pentaerythrityl Tetra-di-tert-butyl Hydroxyhydrocinnamate, Tinogard TT)

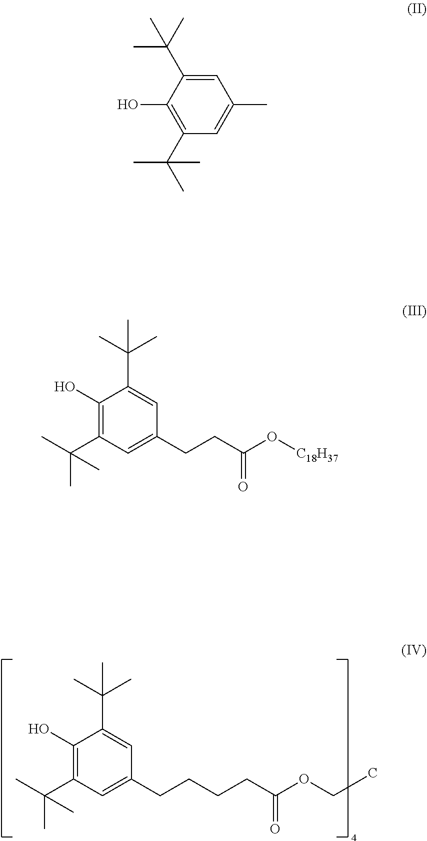

and optionally
(c) one, two or more solvent(s) selected from the group consisting of water, ethanol, dipropylene glycol (DPG), diethyl phtalate (DEP), dimethyl phtalate (DMP), propylene glycol (PG), isopropyl myristate (IPM), isopropyl palmitate (IPP), triethyl citrate (TEC), triacetin (TRI), 1,2-propanediol, 1,3-propanediol, propanetriol, pentanediol, hexanediol, octanediol, decanediol, dodecanol, 4-hydroxyacetophenone (SymSave® H), glycerine, butylene glycol, pentylene glycol, hexylene glycol, decylene glycol, propylene carbonate, butylene carbonate, glycerine carbonate, 2-benzyl heptanol, lauryl alcohol, trimethyl hydroxypentyl isobutyrate, glyceryl caprylate, ethylhexylglycerine, benzyl benzoate (BB), Isopar-L (isoparaffinic hydrocarbons, distillation range 191-211° C.), Isopar-M (isoparaffinic hydrocarbons, distillation range 207-253° C.), Dowanol DPM (dipropylene glycol methylether), Dowanol TPM (tripropylene glycol methylether), dioctyl adipate, hexylene glycol, isopropyl alcohol and isooctanone,
   preferably selected from the group consisting of water, ethanol, dipropylene glycol (DPG), diethyl phtalate (DEP), dimethyl phtalate (DMP), propylene glycol (PG), isopropyl myristate (IPM), isopropyl palmitate (IPP), triethyl citrate (TEC), triacetin (TRI), 1,2-propanediol, 1,3-propanediol, propanetriol, pentanediol, hexanediol, octanediol, decanediol, dodecanol, 4-hydroxyacetophenone (SymSave® H) and benzyl benzoate (BB),
   more preferably selected from the group consisting of water, ethanol, dipropylene glycol (DPG), diethyl phtalate (DEP), propylene glycol (PG), isopropyl myristate (IPM), isopropyl palmitate (IPP), triethyl citrate (TEC) and benzyl benzoate (BB),
and optionally
(d) one, two or more substance(s) or substance mixture(s) selected from the group consisting
   of extracts from natural materials like essential oils, concretes, absolues, resines, resinoides, balsams, tinctures like
   ambra tincture; amyris oil; angelica seed oil; angelica root oil; anise seed oil; valerian oil; basil oil; woodmoss absolue; bay oil; mugwort oil; benzoe resin; bergamot oil; bees wax absolue; birch tar oil; bitter almond oil; savory oil; bucco leaf oil; cabreuva oil; cade oil; calmus oil; campher oil; cananga oil; cardamomen oil; cascarilla oil; cassia oil; cassie absolue; castoreum absolue; cedar leaf oil; cedar wood oil; cistus oil; citronella oil; citrus oil; copaiva balsam; copaiva balsam oil; coriander oil; costus root oil; cumin oil; cypre oil; davana oil; dill herb oil; dill seed oil; Eau de brouts absolue; oakmoss absolue; elemi oil; estragon oil; eucalyptus-citriodora oil; eucalyptus oil; fennell oil; pine needle oil; galbanum oil; galbanum resin; geranium oil; grapefruit oil; guajak wood oil; gurjun balsam; gurjun balsam oil; helichrysum absolue; helichrysum oil; ginger oil; orris root absolue; orris root oil; jasmin absolue; kalmus oil; camilla oil blue; camilla oil; carrot seed oil; cascarilla oil; peppermint oil; caraway oil; labdanum oil; labdanum absolue; labdanum resin; lavandin absolue; lavandin oil; lavender absolue; lavender oil; lemongras oil; lovage oil; limette oil linaloe oil; litsea-cubeba oil; bay leaf oil; macis oil; marjoram oil; mandarin oil; massoi bark oil; mimosa absolue; musk kernel oil; musk tincture; muskatella-sage oil; nutmeg oil; myrrh absolue; myrrh oil; myrtal oil; carnation leaf oil; carnation flower oil; neroli oil; olibanum absolue; olibanum oil; opopanax oil; orange flower absolue; orangen oil; origanum oil; palmarosa oil; patchouli oil; perilla oil; perubalsam oil; parsley leaf oil; parsley seed oil; petitgrain oil; wintergreen oil; pepper oil; piment oil; poley oil; rose absolue; rose wood oil; rose oil; rosmary oil; sage oil; sandal wood oil; celery seed oil; spik lavender oil; star anise seed oil; styrax oil; tagetes oil; tea-tree oil; turpentine oil; thyme oil; tolu balsam; tonka absolue; tuberose absolue; vanilla extract; viole leaf absolue; verbena oil; vetiver oil; juniper berry oil; wine yeast oil; wormwood oil; ylang ylang oil; ysop oil; civet absolue; cinnamon leaf oil; cinnamon bark oil as well as fractions thereof or ingredients isolated thereof;
   ingredients from the group of carbohydrates as e.g. 3-carene; pinene; terpinene; p-cymol; bisabolen; camphene; caryophyllene; cedrene; farnesene; limonene; longifolene; myrcene; ocimene; valencene; (E,Z)-1,3,5-undecatriene; styrol; diphenylmethane;
   of aliphatic alkohols as e.g. hexanol; octanol; 3-octanol; 2,6-dimethylheptanol; 2-methyl-2-heptanol; 2-methyl-2-octanol; (E)-2-hexenol; 1-octen-3-ol; mix of 3,4,5,6,6-pentamethyl-3/4-hepten-2-ol und 3,5,6,6-tetramethyl-4-methylene-heptan-2-ol; (E,Z)-2,6-nonadienol; 3,7-dimethyl-7-methoxyoctan-2-ol; 9-decenol; 10-undecenol; 4-methyl-3-decen-5-ol;
   of aliphatic aldehydes and their acetales as e.g. hexanal; heptanal; octanal; nonanal; decanal; undecanal; dodecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-un-decadienal; heptanaldiethylacetal; 1,1-dimethoxy-2,2,5-trimethyl-4-hexene; citronellyloxyacetaldehyde; 1-(1-methoxy-propoxy)-(E/Z)-3-hexene;
   of aliphatic ketones and their oximes as e.g. 2-heptanone; 2-octanone; 3-octanone; 2-nonanone; 5-methyl-3-heptanone; 5-methyl-3-heptanonoxime; 2,4,4,7-tetramethyl-6-octen-3-one; 6-methyl-5-hepten-2-one;
   of aliphatic sulfur containing substances as e.g. 3-methylthio-hexanol; 3-methylthiohexylacetate; 3-mercaptohexanol; 3-mercaptohexylacetate; 3-mercapto
   hexyl butyrate; 3-acetylthiohexylacetate; 1-menthen-8-thiol;
   of aliphatic nitriles as e.g. 2-nonenoic acid nitrile; 2-undecenoic acid nitrile; 2-tridecenoic acid nitrile; 3,12-tridecadienoic acid nitrile; 3,7-dimethyl-2,6-octa-dienoic acid nitrile; 3,7-dimethyl-6-octenoic acid nitrile;
   of esters of aliphatic carbonic acids as e.g. (E)- und (Z)-3-hexenylformiate; ethylacetoacetate; isoamylacetate; 3,5,5-trimethylhexylacetate; 3-methyl-2-butenylacetate; (E)-2-hexenylacetate; (E)- and (Z)-3-hexenylacetate; octylacetate; 3-octylacetate; 1-octen-3-ylacetate; ethylbutyrate; butylbutyrate; isoamylbutyrate; hexylbutyrate; (E)- and (Z)-3-hexenyl-isobutyrate; hexylcrotonate; ethylisovalerianate; ethyl-2-m ethylpentanoate; ethylhexanoate; allylhexanoate; ethylheptanoate; allylheptanoate; ethyloctanoate; ethyl-(E,Z)-2,4-decadienoate; methyl-2-octinate; methyl-2-noninate; allyl-2-isoamyloxyacetate; methyl-3,7-dimethyl-2,6-octadien-oate; 4-methyl-2-pentyl-crotonate;
   of acyclic terpene alcohols as e.g. geraniol; nerol; lavadulol; nerolidol; farnesol; tetrahydrolinalool; tetrahydrogeraniol; 2,6-dimethyl-7-octen-2-ol; 2,6-di-m ethyloctan-2-ol; 2-methyl-6-methylen-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol 2,6-dimethyl-2,5,7-octatrien-1-ol; as well as their formiates, acetates, propionates, isobutyrates, butyrates, isovalerianates, pentanoates, hexanoates, crotonates, tiglinates und 3-methyl-2-butenoates;
   of acyclic terpene aldehydes und-ketones as e.g. citronellal; 7-methoxy-3,7-dimethyloctanal; 2,6,10-trimethyl-9-undecenal; geranylacetone; as well as the dimethyl-und diethyl acetales of geranial, neral,
   of cyclic terpene alcohols as e.g. menthol; isopulegol; alpha-terpineol; terpinenol-4; menthan-8-ol; menthan-1-ol; menthan-7-ol; borneol; isoborneol; linalooloxid; nopol; cedrol; ambrinol; vetiverol; guajol; as well as their formiates, acetates, propionates, isobutyrates, butyrates, isovalerianates, pentanoates, hexanoates, crotonates, tiglinates and 3-methyl-2-butenoates;
   of cyclic terpene aldehydes and -ketones as e.g. menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethyl-ionone; alpha-irone; beta-damascenone; 1-(2,4,4-trimethyl-2-cyclohexen-1-yl)-2-buten-1-one; 1,3,4,6,7,8a-hexahydro-1,1,5,5-tetramethyl-2H-2,4a-methano-naphthalen-8(5H)-one; 2-methyl-4-(2,6,6-trimethyl-1-cyclo-hexen-1-yl)-2-butenal; nootkatone; dihydronootkatone; 4,6,8-megastigmatrien-3-one; alpha-sinensal; beta-sinensal; acetylised cedar wood oil (methyl cedryl ketone);
   of cyclic alcohols as e.g. 4-tert.-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;
   of cycloaliphatic alcohols as e.g. alpha,3,3-trimethylcyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethyl-cyclohexyl)hexan-3-ol;
   of cyclic and cycloaliphatic ether as e.g. cineol; cedrylmethylether; cyclododecylmethylether; 1,1-dimethoxycyclododecane; (ethoxymethoxy)cyclo-dodecane; alpha-cedrenepoxide; 3a,6,6,9a-tetramethyldodecahydro-naphtho[2,1-b]furane; 3a-ethyl-6,6,9a-trimethyldodecahydronaphtho[2,1b]furane; 1,5,9-tri-methyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;
   of cyclic and macrocyclic ketones as e.g. 4-tert.-butylcyclohexanone; 2,2,5-trimethyl-5-pentylcyclopentanone; 2-heptylcyclopentanone; 2-pentyl-cyclo-pentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopenta-decanone; 4-(1-ethoxyvinyl)-3,3,5,5-tetramethylcyclohexanone; 4-tert.-pentylcyclo-hexanone; 5-cyclohexadecen-1-one; 6,7-dhydro-1,1,2,3,3-pentamethyl-4(5H)-indanone; 8-cyclohexadecen-1-one; 9-cycloheptadecen-1-one; cyclopentadecanone; cyclohexadecanone;
   of cycloaliphatic aldehydes as e.g. 2-methyl-4-(2,2,6-trimethyl-cyclohexen-1-yl)-2-butenal; 4-(4-hydroxy-4-methylpentyl)-3-cyclohexencarbaldehyde; 4-(4-methyl-3-penten-1-yl)-3-cyclohexencarbaldehyde;
   of cycloaliphatic ketones as e.g. 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphtalenylmethylketone; methyl-2,6,10-trimethyl-2,5,9-cyclododecatrienyl ketone; tert.-butyl-(2,4-dimethyl-3-cyclohexen-1-yl)ketone; of esters of cyclic alcohols as e.g. 2-tert-butylcyclohexylacetat; 4-tert-butylcyclohexylacetate; 2-tert-pentylcyclohexylacetate; 4-tert-pentyl-cyclo-hexyl-acetate; 3,3,5-trimethylcyclohexylacetate; decahydro-2-naphthylacetate; 2-cyclopentylcyclopentylcrotonate; 3-pentyltetrahydro-2H-pyran-4-ylacetate; deca-hydro-2,5,5,8a-tetramethyl-2-naphthylacetate; 4,7-methano-3a,4,5,6,7,7a-hexa-hydro-5, and/or 6-indenylacetate; 4,7-methano-3a,4,5,6,7,7a-hexahydro-5, and/or 6-indenyl-propionate; 4,7-Methano-3a,4,5,6,7,7a-hexahydro-5, and/or 6-inden-ylisobutyrate; 4,7-methanooctahydro-5, and/or 6-indenylacetate;
   of esters of cycloaliphatic alcohols as e.g. 1-cyclohexylethylcrotonate; of esters of cycloaliphatic carbonic acids as e.g. allyl-3-cyclohexylpropionate; allylcyclohexyloxyacetate; cis- and trans-methyldihydrojasmonate; cis- and trans-methyljasmonate; methyl-2-hexyl-3-oxocyclopentancarboxylate; ethyl-2-ethyl-6,6-dimethyl-2-cyclohexencarboxylate; ethyl-2,3,6,6-tetramethyl-2-cyclohexen-carboxylate ethyl-2-methyl-1,3-dioxolan-2-acetate;
   of araliphatic alcohols as e.g. benzyl alcohol; 1-phenylethyl alcohol; 3-phenyl propanol; 2-phenyl propanol; 2-phenoxy ethanol; 2,2-dimethyl-3-phenyl propanol; 2,2-dimethyl-3-(3-methylphenyl) propanol; 1,1-dimethyl-2-phenylethyl alcohol; 1,1-dimethyl-3-phenyl propanol; 1-ethyl-1-methyl-3-phenyl propanol; 2-methyl-5-phenyl pentanol; 3-methyl-5-phenyl pentanol; 3-phenyl 2-propen-1-ol; 4-methoxybenzyl alcohol; 1-(4-isopropylphenyl) ethanol;
   of ester of araliphatic alcohols and aliphatic carbonic acids as e.g. benzyl acetate; benzyl propionate; benzyl isobutyrate; benzyl isovalerianate; 2-phenyl ethylacetate; 2-phenyl ethylpropionate; 2-phenyl ethylisobutyrate; 2-phenyl ethylisovalerianate; 1-phenyl ethylacetate; alpha-trichlormethyl benzyl acetate; alpha,alpha-dimethyl phenyl ethylacetate; alpha,alpha-dimethyl phenyl ethylbutyrat; cinnamyl acetate; 2-phenoxyethyl isobutyrate; 4-methoxy benzyl acetate;
   of araliphatic ether as e.g. 2-phenyl ethylmethylether; 2-phenyl ethyl-isoamyl-ether; 2-phenyl ethyl-1-ethoxyethylether; phenyl acetaldehyde dimethylacetal; phenyl acetaldehyddiethyl acetal; hydratropaaldehyd dimethylacetale; phenyl acetaldehydglycerinacetale; 2,4,6-trimethyl 4-phenyl-1,3-dioxane; 4,4a,5,9b-tetra-hydroindeno[1,2-d]-m-dioxin; 4,4a,5,9b-tetrahydro-2,4-dimethylindeno[1,2-d]-m-dioxin;
   of aromatic and araliphatic aldehyde as e.g. benzaldehyde; phenyl acetaldehyde; 3-phenyl propanal; hydratropaaldehyde; 4-methyl benzaldehyde; 4-methyl phenyl acetaldehyde; 3-(4-ethylphenyl) 2,2-dimethylpropanal; 2-methyl-3-(4-isopropylphenyl) propanal; 2-methyl-3-(4-isobutylphenyl) propanal; 3-(4-tert.-butyl-phenyl) propanal; cinnamic aldehyde; alpha-butyl cinnamic aldehyde; alpha-hexyl cinnamic aldehyde; 3-methyl-5-phenyl pentanal; 4-methoxy benzaldehyde; 4-hydroxy-3-methoxy benzaldehyde; 4-hydroxy-3-ethoxy benzaldehyde; 3,4-methylendioxy benzaldehyde; 3,4-dimethoxy benzaldehyde; 2-methyl-3-(4-methoxyphenyl) propanal; 2-methyl-3-(4-methylendioxyphenyl) propanal;
   of aromatic and araliphatic ketones as e.g. acetophenone; 4-methyl acetophenone; 4-methoxy acetophenone; 4-tert.-butyl-2,6-dimethyl acetophenone; 4-phenyl-2-butanone; 4-(4-hydroxyphenyl)-2-butanone; 1-(2-naphtha-lenyl) ethanone; 2-benzofuranylethanon; (3-methyl-2-benzofuranyl) ethanone; benzo-phenone; 1,1,2,3,3,6-hexamethyl-5-indanyl methylketone; 6-tert.-butyl-1,1-dimethyl-4-indanyl methylketone; 1-[2,3-dihydro-1,1,2,6-tetramethyl-3-(1-meth-ylethyl)-1H-5-indenyl]ethanon; 5′,6′,7′,8′-Tetrahydro-3′,5′,5′,6′,8′,8′-hexamethyl-2-aceto-naphthone;
   of aromatic and araliphatic carbonic acids and their esters as e.g. benzoic acid; phenyl acetic acid; methyl benzoate; ethyl benzoate; hexyl benzoate; methylphenyl acetate; ethylphenyl acetate; geranyl phenyl acetate; phenylethyl phenyl acetate; methyl cinnamate; ethyl cinnamate; benzyl cinnamate; phenylethyl cinnamate; cinnamyl cinnamate; allyl phenoxy acetate; methyl salicylate; hexyl salicylate; cyclohexyl salicylate; cis-3-hexenyl salicylate; benzyl salicylate; phenylethyl salicylate; methyl-2,4-dihydroxy-3,6-dimethyl benzoate; ethyl-3-phenyl glycidate; ethyl-3-methyl-3-phenyl glycidate;
   of nitrogen containing aromatic substances as e.g. 2,4,6-trinitro-1,3-dimethyl-5-tert.-butyl benzol; 3,5-dinitro-2,6-dimethyl-4-tert.-butyl acetophenone; cinnamic acid nitrile; 3-methyl-5-phenyl-2-pentenoic acid nitrile; 3-methyl-5-phenylpentanoi acid nitrile; methyl anthranilate; methyl-N-methyl anthranilate; Schiff bases of methyl anthranilate with 7-hydroxy-3,7-dimethyloctanal, 2-methyl-3-(4-tert.-butyl-phenyl)propanal or 2,4-dimethyl-3-cyclohexencarbaldehyde; 6-Isopropyl chinoline; 6-Isobutyl chinoline; 6-sec.-butyl chinoline; 2-(3-phenylpropyl) pyridin; indole; skatole; 2-methoxy-3-isopropyl pyrazine; 2-isobutyl-3-methoxy pyrazine;
   of phenoles, phenylethers and phenylesters as e.g. estragol; anethol; eugenyl methylether; isoeugenol; isoeugenyl methylether; thymol; carvacrol; diphenylether; beta-naphthyl methylether; beta-naphthyl ethylether; beta-naphthyl iso-butylether; 1,4-dimethoxy benzol; eugenyl acetate; 2-methoxy-4-methyl phenol; 2-ethoxy-5-(1-propenyl) phenol; p-cresyl phenylacetate;
   of heterocyclic substances as e.g. 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
   of lactones as e.g. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecan-olide; 1,16-hexadecanolide; 9-hexadecen-1,16-olide; 10-oxa-1,16-hexa-decanolide; 11-oxa-1,16-hexa-decanolide; 12-oxa-1,16-hexadecanolide; ethylen-1,12-dodecandioate; ethylen-1,13-tridecandioate; 2,3-dihydrocumarin; octahydrocumarin,
wherein the total amount of compound(s) of group (a) in the composition is 0.05 to 10 wt.-%, preferably 0.05 to 5 wt.-%, more preferably 0.05 to 3 wt.-%, particularly preferably 0.1 to 1 wt.-%,
and wherein the total amount of compound(s) of group (b) in the composition is 0.0001 to 1 wt.-%, preferably 0.001 to 0.5 wt.-%, more preferably 0.001 to 0.25 wt.-%, particularly preferably 0.01 to 0.1%,
and wherein the total amount of compound(s) of group (c), if present, in the composition is 0.000001 to 99.9 wt.-%, preferably 0.00001 to 99.9 wt.-%, more preferably 0.0001 to 99.9 wt.-%,
and wherein the total amount of substance(s)/substance mixture(s) of group (d), if present, in the composition is 0.000001 to 99.9 wt.-%, preferably 0.00001 to 95 wt.-%, more preferably 0.0001 to 95 wt.-%,
   in each case based on the total weight of the composition.

In a preferred embodiment of the invention, the composition according to the invention is a liquid or a solid under standard conditions. Standard conditions are meant to be understood as 25° C. and a pressure of 1 bar.

As a liquid or solid under standard conditions, such compositions can advantageously be used as or in e.g. washing or cleaning agents.

In a further preferred embodiment of the invention, the composition comprises water in a total amount of 0.0000001 to 90 wt.-%, based on the total weight of the composition.

Water as a component of the composition according to the invention can serve as a solvent and thus facilitate mixing the different components of the composition according to the invention. Furthermore, it may facilitate mixing such a composition into a further composition/product in which it may be used.

Another aspect of the present invention relates to a method for producing a composition according the invention, comprising or consisting of the following steps:
(i) Providing compounds of group (a) and (b) as defined above,
(ii) optionally providing compound(s) of group (c) as defined above,
(iii) optionally providing substance(s)/substance mixture(s) of group (d) as defined above,
(iv) mixing compounds of group (a) and (b) and, if applicable, of group (c) and/or substance(s)/substance mixture(s) of group (d).

An alternative aspect of the present invention relates to a method for producing a composition according to the invention and comprising water in a total amount of 0.0000001 to 90 wt.-%, based on the total weight of the composition, as described above, comprising or consisting of the following steps:
(i) Providing compounds of group (a) and (b) as defined above,
(ii) providing compound(s) of group (c) as defined above, wherein the or one of the solvent(s) is water, and wherein the water is provided in a total amount of 0.0000001 to 50 wt.-%, based on the total weight of the composition,
(iii) optionally providing substance(s)/substance mixture(s) of group (d) as defined above,
(iv) mixing compounds of group (a), (b) and (c) and, if applicable, substance(s)/substance mixture(s) of group (d).

Another aspect of the present invention relates to the use of a composition according to the invention as an anti-malodor agent, preferably for fabric, clothes and/or laundry, preferably in laundry care products.

Compositions according to the invention are used anti-malodor agents. Such malodors are typically found on cleaned/washed clothes/laundry, often showing a musty, mouldy malodor after being washed or cleaned. These malodors arise from the metabolization of remaining ingredients of the cleaning/washing liquor after cleaning/washing, resulting in the formation of odor active compounds. Additionally, chemical or enzymatic degradation may raise or trigger such effect.

Therefore, it is advantageous that the composition according to the invention can be used as an anti-malodor agent, especially on fabric, clothes and/or laundry and particularly in laundry care products.

Another aspect of the present invention relates to a preparation comprising or consisting of
(a) a composition according to the invention,
and
(b) one, two or more surface active compound(s) selected from the group consisting of alkyl carboxylate, alkyl sulfonate, alkyl sulphate, alcohol polyglycol ether sulfate, quarternary ammonium cations, quarternary ammonium ester, alcohol polyglycol ether, N-(acylaminoalkyl)-betaine, polyethylene glycol alkyl ether, alkyl benzene sulfonate, TEA-esterquat,
   preferably selected from the group consisting of lauryl ether sulfate, betaine, lauryl alkyl sulfate, PEG hydrogenated castor oil, laureth-5, laureth-6, laureth-7, dialkylesterammoniumethosulfate, sodium stearate, sodium palmitate, polyethylene glycol, zinc stearate, sodium caprylate, lauric acid, Isopar-L (isoparaffinic hydrocarbons, distillation range 191-211° C.), sodium dodecyl benzene sulfonate, dihydrogenated tallowethyl hydroxyethylmonium methosulfate, cocos fatty acids, sodium dodecylbenzenesulfonate, diethylenetriamine pentamethylene phosphonic acid sodium salt, disodium distyrylbiphenyl disulfonate, Trideceth-9,5-chloro-2-methyl-2H-isothiazol-3-one, 2-methyl-2H-iso-thiazol-3-one, C13-17-sec-alkyl-sulfonic acid sodium salt, sodium tallowate, sodium cocoate, sodium palm kernelate, sodium fatty alcohol C12-C18, dialkylesterammonium-ethosulfate and polydimethylsiloxane.

As in one embodiment of the invention, the composition according to the invention may be used for cleaning/washing or may be mixed into preparations for cleaning/washing, it is of particular advantage that these preparations further include surface active compounds (i.e. surfactants), which further provide a cleaning/washing function or a support therein.

In one embodiment of the present invention, the preparation according to the invention is a laundry care product, preferably wherein the preparation is a laundry care product selected from the group consisting of liquid detergent, heavy duty liquid detergent, high-pH liquid detergent, powder detergent, heavy duty powder detergent, detergent bar, fabric softener, fabric softener concentrate, water softener powder, water softener tab, water softener gel, bleach, spot remover, laundry hygiene and pre-wash detergent.

In a further embodiment of the present invention, the total amount of the composition according to the invention in the preparation is sufficient to provide an anti-malodor effect, preferably wherein the total amount of composition according to the invention in the preparation, based on the total weight of the preparation, is 0.05 to 10 wt.-%, preferably 0.05 to 5 wt.-%, more preferably 0.05 to 3 wt.-%, particularly preferably 0.1 to 1 wt.-%.

In another embodiment of the present invention, the weight ratio of the total amount of composition according to the invention in the preparation to the total amount of surface active compound(s) in the preparation is in the range of 1:1600 to 10:1, preferably 1:1600 to 5:1, more preferably 1:800 to 3:1.

Common products used in the state of the art are typically designed to almost completely remove microorganisms from the clothes/laundry and/or also from the washing machine. Therefore, high concentrations of the included substances (i.e. antimicrobial active compounds like Triclosan, cationic surfactants or silver salts) are required in such products. The use of such compounds needs to be carefully considered, as they might trigger the formation and the enrichment of multi-resistant microorganisms when used and show considerable disadvantages caused by their biodegradability when used e.g. in cleaning/washing or laundry care. Additionally, as the clothes/laundry will subsequently be in contact with human skin, typically for a long time, a low concentration of active substances is beneficial.

It is thus a clear advantage of the composition according to the invention and a preparation according to the invention comprising such a composition that the active ingredients may be used in rather low concentrations. Therefore, the problems and risks arising from high concentrations in typical products in the state of the art can be critically reduced.

As can be derived from the examples below, the combination of Jasmol and BHT provides a synergistic effect in reducing malodor.

Another aspect of the present invention relates to the use of such a preparation, as described above, as an anti-malodor agent, preferably for fabric, clothes and/or laundry.

An even further aspect of the present invention is a method for producing a preparation according to the invention, comprising or consisting of the following steps:
(i) Providing a composition according to the invention, preferably by a method according to the invention, or the ingredients of a composition according to the invention,
(ii) providing one, two or more surface active compound(s) as defined above,
(iii) mixing the components of (i) and (ii).

Another aspect of the present invention is the use of a composition according to the invention or of a preparation according to the invention, preferably of a laundry care product as defined above, to reduce and/or modify a malodor, preferably a musty and/or mouldy malodor, preferably of fabric, clothes and/or laundry, preferably during and/or after washing of said fabric, clothes and/or laundry.

In one embodiment of the present invention, the composition according to the invention or the preparation according to the invention, preferably a laundry care product as defined above, is used at a washing temperature of 60° C. or less, preferably at a washing temperature of 45° C. or less, 40° C. or less or 30° C. or less.

In the state of the art, a possibility to prevent the formation of malodor as described above is to use cleaning/washing temperatures of higher than 60° C. and washing detergents with oxidizing agents and/or higher amounts of strong antimicrobial active compounds, like Triclosan, cationic surfactants or silver salts. However, not all of the clothes/laundry is suited to be cleaned/washed at such high temperatures and not all substances comprised in the used compositions (or preparations, where applicable) are stable at such high temperature. Therefore, it is of particular advantage that the washing temperature can be reduced to 60° C. or less, preferably 45° C. or less, 40° C. or less or 30° C. or less.

Preferred embodiments and further aspects of the present invention emerge from the attached patent claims, the figures and the following examples, the examples not being in-tended to limit the scope of the present invention.

### EXAMPLES

### Example 1: Experiment A

The aim of this experiment was to investigate the ability of the inventive anti-malodor composition to reduce the intensity of the musty, mouldy malodor. The test was done in comparison with Triclosan which is a common strong active for Laundry Care products and Personal Care products, further comparing compositions 1 to 5 (references) and 6 (composition according to the invention).

Used Materials and Solutions:
Washing liquor 4 kg of worn clothes were washed in a European washing machine at 40° C. with unperfumed liquid detergent (40 g). The washing liquor (ca 6 L) of the first wash cycle was used for this experiment. The used washing liquor was 4 hours old when experiment A was started.
Test fabric 100% cotton; unworn; 4×4 cm square
Composition For the production of the composition 1 to 6 all ingredients of table 1 were mixed.

TABLE 1
Tested compositions of experiment A

| | | | Composition | | | | | |
|---|---|---|---|---|---|---|---|---|
| Supplier | INCI | Ingredient | 1 | 2 | 3 | 4 | 5 | 6 |
| Symrise AG | 2-Benzylheptanol | Jasmol | — | — | — | 5 | — | 5 |
| Sigma Aldrich | 3,5-Di-tert-butyl-4- | BHT | — | — | — | — | 0.1 | 0.1 |
| | hydroxytoluene | | | | | | | |
| Sigma Aldrich | 5-Chloro-2-(2,4- | Triclosan | — | — | 5 | — | — | — |
| | dichlorophenoxy)phenol | | | | | | | |
| Sigma Aldrich | Isopropylmyristate | IPM | — | 100 | 95 | 95 | 99.9 | 94.9 |
| | Aqua | water | 100 | — | — | — | — | — |
| | | total | 100 | 100 | 100 | 100 | 100 | 100 |

The test fabric was put into an Erlenmeyer flask, each in one flask. 1 ml of each composition 1 to 6 was dropped in the middle of the test fabric. Each flask was closed with aluminum foil and stored for 48 h at room temperature. After 48 h, each flask was sensorially evaluated by an expert panel of 6 to 11 persons. The intensity of the typical musty, mouldy malodor was determined on a scale of 0 to 40. The determined malodor intensities were compared with the malodor intensity of composition 1. The percentage reduction of the malodor intensity compared to composition 1 was calculated. The results are shown in table 2.

TABLE 2
Results of the sensorial evaluation of experiment A

| | Composition | | | | | |
|---|---|---|---|---|---|---|
| | 1 | 2 | 3 | 4 | 5 | 6 |
| measured malodor intensity | 39 | 39 | 31 | 13 | 35 | 6 |
| malodor reduction compared to | — | 0 | 21 | 67 | 10 | 85 |
| composition 1 [%] | | | | | | |

Surprisingly, composition 6, with the combination of Jasmol and BHT and being according to the invention, showed the highest value of 85% for malodor reduction compared to composition 1, remarkably more than composition 4 and 5 with the single compounds. Composition 3 with the antimicrobial Triclosan showed low ability to reduce the malodor in contrast to composition 4 with Jasmol and composition 6 with the combination of Jasmol and BHT and being according to the invention.

### Example 2: Experiment B—In-Use Test Fabric Softener

In experiment B the active compositions were tested under realistic conditions in a fabric softener composition in a rinsing program. Compositions I to IV (reference) were compared to composition V (according to the invention).

Used Materials and Solutions:

Rinsed test fabric For the production of the rinsed test fabric squares, the 5 unused test fabric squares+4 kg cotton laundry were used with fabric softener in a European washing machine. For this rinsing procedure, only the rinsing program was used without the washing program. 40 g of one fabric softener composition were used for one rinsing procedure. The rinsing procedure was 5 times repeated with the same fabric softener composition and the same test fabric squares to simulate realistic-worn clothes which were washed several times. Table 3 showed the used fabric softener compositions I to V. Use the wet fabric softener squares for the experiment.
Washing liquor 4 kg of worn clothes was washed in a European washing machine at 40° C. with unperfumed liquid detergent (40 g). The washing liquor (ca 6 L) of the first wash cycle was used for this experiment. The used washing liquor was 4 hours old when the experiment B was started.
Test fabric 100% cotton; unworn; 4×4 cm square
Fabric softener Table 3 shows the ingredients of fabric softener compositions I to V. composition

For providing the fabric softener compositions, the water is heated up to approx. 45° C. Rewoquat is added while stirring and it is heated to 50° C. When the Rewoquat is dissolved completely, first Parmetol and second Xiameter is added and dissolved. Magnesium chloride solution is added, not below 30° C., to maintain a good processing viscosity (50 m PA s). It is stirred for about 30 minutes and cooled to approx. 25° C. The other ingredients are added. The pH-value is 2.5. A Brookfield Spindle 2, Speed 60 is used for the manufacturing.

TABLE 3
Tested fabric softener compositions of experiment B

| | | | | Fabric softener composition | | | | |
|---|---|---|---|---|---|---|---|---|
| Supplier | INCI | | Ingredient | I | II | III | IV | V |
| | Aqua | 1 | water, demin. | 81.5 | 81.5 | 81.5 | 81.9 | 81.4 |
| Goldschmidt | Di-(Talg Carboxyethyl) | 2 | Rewoquat WE 18 | 16.6 | 16.6 | 16.6 | 16.6 | 16.6 |
| Rewo GmbH | Hydroxyethyl methyl- | | | | | | | |
| | ammoniummethosulfate | | | | | | | |
| Hoesch Julius | N, S-heterocyclen | 3 | Parmetol K 40 | 0.1 | 0.1 | 0.1 | 0.1 | 0.1 |
| Biesterfeld | Simethicone | 4 | Xiameter AFE-1520 | 0.3 | 0.3 | 0.3 | 0.3 | 0.3 |
| Spezialchemie | | | | | | | | |
| GmbH | | | | | | | | |
| | | 5 | Magnesium chloride | 1.0 | 1.0 | 1.0 | 1.0 | 1.0 |
| | | | 32% solution | | | | | |
| Symrise AG | 2-benzylheptanol | | Jasmol | — | — | 0.5 | — | 0.5 |
| Sigma Aldrich | 3,5-Di-tert-butyl-4- | | BHT | — | — | — | 0.1 | 0.1 |
| | hydroxytoluene | | | | | | | |
| Sigma Aldrich | 5-Chloro-2-(2,4- | | Triclosan | — | 0.5 | — | — | — |
| | dichlorophenoxy)phenol | | | | | | | |
| | Aqua | | water, demin. | 0.5 | — | — | — | — |
| | | | total | 100 | 100 | 100 | 100 | 100 |

Test Procedure:

One wet fabric square of each fabric softener composition is put into an Erlenmeyer flask, each in one flask. 1 mL of the washing liquor is dropped on the fabric square in the middle of each flask. Each flask was closed with aluminum foil and stored for 48 h at room temperature. After 48 h each flask was sensorial evaluated by an expert panel of 6 to 11 persons. The intensity of the typical musty, mouldy malodor was determined on a scale of 0 to 40. The determined malodor intensities were compared with the malodor intensity of fabric softener composition I. The percentage reduction of the malodor intensity was calculated. The results are shown in table 4.

TABLE 4
Results of the sensorial evaluation of experiment B

| | Fabric softener composition | | | | |
|---|---|---|---|---|---|
| | I | II | III | IV | V |
| measured malodor intensity | 39 | 35 | 15 | 37 | 10 |
| malodor reduction compared to | — | 10 | 62 | 5 | 74 |
| fabric softener composition I [%] | | | | | |

Surprisingly, fabric softener composition V, with the combination of Jasmol and BHT and being according to the invention, showed the highest value of 74% for malodor reduction compared to fabric softener composition I, remarkably more than fabric softener composition III and IV with the single compounds. Fabric softener composition II with the antimicrobial Triclosan showed a low ability to reduce the malodor in contrast to composition III with Jasmol and composition V with the combination of Jasmol and BHT and being according to the invention.

### Example 3: Perfume Composition A

TABLE 5
Perfume composition A

| Material | Wt-% |
|---|---|
| DODECANLACTON-GAMMA | 0.4000 |
| ETHANOL | 2.0000 |
| GERANIOL | 1.5000 |
| DPG | 2.5000 |
| TOCOPHEROL | 0.0500 |
| AGRUMEX LC | 0.5000 |
| ALDEHYDE C14 SOGENANNT | 0.2000 |
| AMAROCIT ® (6,6-DIMETHOXY-2,5,5-TRIMETHYL-2-HEXENE) | 0.2000 |
| AMBERWOOD ® F (ETHOXYMETHOXY)-CYCLODODECANE) | 1.0000 |
| BENZOIN SIAM RESIN 50% IN BB | 0.3000 |
| BERGAMOT SYNTHESSENCE AFRIKANISCH | 4.0000 |
| BHT IONOL | 0.0500 |
| CEDER WOOD OIL VIRGINIA | 3.0000 |
| CEDRAMBER | 1.5000 |
| COUMARIN | 0.3000 |
| DIETHYLMALONAT | 0.8000 |
| DIHYDROMYRCENOL | 0.8000 |
| ETHYLDECADIENOAT TRANS CIS-2,4 10% in IPM | 1.0000 |
| ETHYL VANILLIN | 0.4000 |
| ETHYLENBRASSYLAT | 12.0000 |
| FLOROSA | 3.0000 |
| GERANYL ACETAT | 0.5000 |
| GINGER OIL CHINESE | 0.2000 |
| GIVESCONE 10% in DPG | 0.6000 |
| HEDIONE | 6.5000 |
| HELIONAL | 3.0000 |
| HEXENYLACETAT CIS-3 10% in DPG | 2.0000 |
| HEXYL SALICYLAT | 6.5000 |
| JASMOL (2-BENZYLHEPTANOL) | 0.3000 |
| INDOLE 10% in DPG | 0.3000 |
| ISO E SUPER | 22.5000 |
| LINALOOL | 3.0000 |
| LINALYLACETAT | 4.0000 |
| METHYLANTHRANILAT | 0.2000 |
| METHYL NAPHTYL KETON BETA KRIST. | 0.3000 |
| NEROLIDOL | 0.5000 |
| ORANGE OIL BRASILIAN | 6.0000 |
| PRENYLACETAT 10% in DPG | 1.0000 |
| SANDRANOL ® (2-ETHYL-4-(2,2,3-TRIME-3-CYCLOPENTENYL)- | 1.0000 |
| 2E-BUTENOL) | |
| STYRALLYLACETAT 10% in DPG | 0.8000 |
| SYMROXANE ® (7-METHOXY-1,1,5,5-TETRAME-2,4A- | 0.3000 |
| METHANO-1,3,4,5,6,7-HH-2H-NAPHTHALIN) | |
| TETRAHYDROLINALOOL | 5.0000 |
| Total | 100.0000 |

### Example 4: Perfume Composition B

TABLE 6
Perfume composition B

| Material | Wt-% |
|---|---|
| 4-HYDROXY-ACETOPHENON | 0.6592 |
| AGRUNITRIL | 0.3406 |
| ALDEHYD C12 MNA 1% DPG | 0.4395 |
| ALKOHOL C10 | 0.0013 |
| ALLYLAMYLGLYCOLAT | 1.2635 |
| AMBERWOOD ® F ((ETHOXYMETHOXY)- | 0.2527 |
| CYCLODODECANE) | |
| AMBROCENIDE ® (CEDRENDIOLACETONIDE) 10% DPG | 0.2087 |
| AMBROXIDE 10% IPM | 0.3296 |
| AMYLSALICYLAT | 1.5491 |
| BAYOEL | 0.0008 |
| BENZYLACETAT | 1.1316 |
| BENZYLBENZOAT M | 0.0006 |
| BENZYLSALICYLAT | 5.7900 |
| BHT | 0.0220 |
| BORNEOL L/ISOBORNEOL 65/35 | 0.0162 |
| BORNYLACETAT L KRIST. | 0.0005 |
| BUTYLENCARBONAT | 0.2197 |
| CALONE 10% DPG | 0.1428 |
| CAMPHEN L SUPRA | 0.1428 |
| CANTHOXAL | 0.1099 |
| CARDAMOMEN OIL | 0.0011 |
| CARYOPHYLLEN NAT. REKT. | 0.0079 |
| CEDER LEAF OIL | 0.2637 |
| CEDER WOOD OIL CHIN. | 0.0005 |
| CEDRAMBER | 2.8346 |
| CINNAMON LEAF OIL DISCOL. | 0.1648 |
| CISTUS LABDANUM ABS. SIS 10% DPG | 0.1099 |
| CITRAL MELANGE | 0.0008 |
| CITRIC ACID MONOHYDRATE 10% DPG | 0.9229 |
| CITRONELLOL | 0.0280 |
| CITRONELLYLFORMIAT | 0.0099 |
| CITRONELLYLTIGLI NAT | 0.0049 |
| COPAIVABALSAM OIL | 0.0022 |
| COUMARONE | 0.1318 |
| CUMARIN | 0.4065 |
| CUMINALDEHYD | 0.0549 |
| CUMINALKOHOL | 0.0989 |
| CYMOL PARA SUPRA | 0.0003 |
| DAMASCONE DELTA | 0.0879 |
| DECALACTON-GAMMA | 0.2197 |
| DEP | 0.5493 |
| DIHYDROEUGENOL | 0.0989 |
| DIHYDROMYRCENOL | 33.8609 |
| DIMETHYL SULFIDE/10% IN TEC | 0.0003 |
| DODECALACTON-GAMMA | 0.4395 |
| DYNASCONE | 0.0001 |
| ETHANOL | 1.0987 |
| ETHYLHEXYLGLYCERIN | 0.1099 |
| EUCALYPTOL NAT. | 0.0154 |
| EUCALYPTUS OIL GLOBULUS 80/85% | 0.8917 |
| EUGENOL NAT. | 0.1192 |
| EVERNYL | 0.4175 |
| FARENAL ® (2,6,10-TRIMETHYL-9-UNDECENAL) 10% DPG | 0.0989 |
| FENCHON D 10% DPG | 0.1099 |
| FLORAZON | 0.0439 |
| FLORHYDRAL 10% DPG | 0.0549 |
| FLOROSA BM/PYRANOL | 0.9778 |
| FRAMBINON ® (4-(4-HYDROXYPHENYL)-2-BUTANONE) | 0.5823 |
| 10% DPG | |
| GALAXOLIDE | 3.8453 |
| GALBANOLEN SUPER | 0.0879 |
| GERANIOL SUPRA | 0.0428 |
| GERANYLACETAT 60 | 0.0028 |
| GERANYLFORMIAT SUPRA | 0.0198 |
| GLOBALIDE ® (OXACYCLOHEXADECEN-2-ONE) | 0.5493 |
| GURJUNBALSAM OIL | 0.0071 |
| HEDIONE | 0.4066 |
| HELIOTROPIN/PIPERONAL | 0.2307 |
| HERCOLYN D-E | 0.0037 |
| HEXALACTON GAMMA 10% DPG | 0.2307 |
| HEXANDIOL | 0.2197 |
| HEXENOL BETA GAMMA CIS,TRANS-3 | 0.0002 |
| HEXENOL CIS-3 | 0.1108 |
| HEXENYLACETAT CIS,TRANS-3 10% DPG | 0.1648 |
| HEXYLSALICYLAT | 2.0215 |
| HEXYLZIMTALDEHYD ALPHA | 4.3397 |
| ISO E SUPER | 14.1069 |
| ISOAMYLALKOHOL | 0.0002 |
| ISOBORNYLACETAT | 0.9229 |
| ISOBORNYLCYCLOHEXANOL | 1.4283 |
| ISOBUTYLCHINOLIN DL 100% | 0.0439 |
| ISOEUGENOLMETHYLETHER | 0.0004 |
| ISOMENTHON | 0.0148 |
| JASMOL | 0.2167 |
| KAMPFER DL | 0.4065 |
| LAVANDIN OIL GROSSO NAT. CENSO | 0.0831 |
| LIGUSTRAL | 0.0010 |
| LIMONEN D REIN | 0.0786 |
| LINALOOL | 2.5269 |
| LINALOOLOXID | 0.0008 |
| LINALYLACETAT | 0.1206 |
| MACIS OIL | 0.0879 |
| MAJANTOL ® (2,2-DIMETHYL-3-(3- | 0.3626 |
| METHYLPHENYL)PROPANOL) | |
| MAJORAN OIL AEGYPT. | 0.0004 |
| MALTOL | 0.0004 |
| MANDARINE ALDEHYD 10% IN TEC 10% BB | 0.0879 |
| MANZANATE 10% DPG | 0.2637 |
| MENTHANYLACETAT | 1.1536 |
| MINTONAT | 0.4395 |
| MYRCEN | 0.0015 |
| NEROL 900 | 0.0016 |
| NEROLIDOL | 0.0033 |
| OCIMEN | 0.0022 |
| OCTANDIOL | 0.2197 |
| OCTANON-3 | 0.0012 |
| OCTENOL-1,3 | 0.0014 |
| ORANGE OIL | 0.0001 |
| OXANTHIA 50% IN TEC | 0.0011 |
| PATCHOULI OIL | 1.6260 |
| PELARGON ACID | 0.0002 |
| PENTANDIOL | 0.2197 |
| PENTYLFORMIAT | 0.0003 |
| PEPPER OIL BLACK 10% BB | 0.2857 |
| PHELLANDREN FRAKTION EX EUCALYPTUSOEL | 0.0038 |
| PHENYLETHYLALKOHOL | 0.1209 |
| PIMENT OIL | 0.0002 |
| PINEN ALPHA LAEVO NAT. | 0.2857 |
| PINEN BETA NAT. | 0.0878 |
| PINOACETALDEHYD | 0.0330 |
| PRECYCLEMONE B | 0.1318 |
| PROPANDIOL | 0.8789 |
| RHUBOFIX | 0.0011 |
| ROSENOXID | 0.0016 |
| ROSENOXID HIGH CIS | 0.0001 |
| ROSMARY OIL | 0.2637 |
| SANDRANOL ® (2-ETHYL-4-(2,2,3-TRIME-3- | 0.6592 |
| CYCLOPENTENYL)-2E-BUTENOL) | |
| STERNANIS OIL 10% TEC | 0.0002 |
| TERPINEN GAMMA | 0.0002 |
| TERPINENOL-4 NAT. | 0.0020 |
| TERPINEOL ALPHA | 0.0030 |
| TERPINEOL REIN | 0.1195 |
| TETRAHYDROGERANIOL | 0.0000 |
| TONALID | 2.7467 |
| TRIETHYLCITRATE | 0.0584 |
| VELOUTONE | 0.0011 |
| VERTOCITRAL | 0.1647 |
| WATER | 0.0001 |
| Total | 100.0000 |

### Example 5: Perfume Composition C

TABLE 7
Perfume composition C

| Material | Wt-% |
|---|---|
| 1,4-CINEOL | 0.3000 |
| ALLYLAMYLGLYCOLAT (ACETIC ACID ALLYLESTER, 2- | 1.0000 |
| METHYLBUTOXY-) | |
| BHT | 1.0000 |
| CALONE ® 1951 10% in DPG (BENZODIOXEPINON, 7- | 3.0000 |
| METHYL-3,4-DIHYDRO-3-) | |
| DAMASCON ALPHA 1% in DPG ((E/Z)-1-(2,6,6-Trimethyl- | 1.0000 |
| cyclohex-2-enyl)-but-2-en-1-on) | |
| DECALACTON-DELTA | 0.0020 |
| DIHYDROMYRCENOL | 2.0000 |
| DPG | 50.1480 |
| ETHANOL | 0.5000 |
| ETHYLENBRASSYLAT (1,13-TRIDECANEDIOIC ACID | 2.5000 |
| ETHYLENE ESTER) | |
| FARENAL ® 1% in DPG (UNDECENAL, 2,6,10-TRIMETHYL- | 0.5000 |
| 9-) | |
| FLORALOZONE (PROPANAL, 2-METHYL-2-(4- | 2.0000 |
| ETHYLBENZYL)- | |
| FREESIOL | 1.5000 |
| GLOBALIDE ® (PENTADECEN-1,15-OLID, 11E/Z) | 2.0000 |
| HEDION ® (METHYL-CIS/TRANS-DIHYDROJASMONAT) | 7.0000 |
| HEXYLSALICYLAT | 2.0000 |
| HEXYLZIMTALDEHYD ALPHA | 1.7000 |
| ISO E SUPER ® (BICYCLO[4.4.0]DECEN, 3-ACETYL- | 2.5000 |
| 3,4,10,10-TETRAMETHYL-1(6)-) | |
| JASMOL | 5.0000 |
| KEPHALIS (CYCLOHEXANON, 3,3,5,5-TETRAMETHYL-4-(1- | 1.0000 |
| ETHOXYVINYL)-) | |
| LEAFOVERT ® 10% in DPG (CARBONIC ACID-3Z- | 2.0000 |
| HEXENYLMETHYLESTER) | |
| LIGUSTRAL ® 10% in DPG (CYCLOHEXEN, TRANS-2,4- | 0.8000 |
| DIMETHYL-1-FORMYL-3-) | |
| LILIAL ® (PROPANAL, 2-METHYL-3-(4-TERT.- | 1.0000 |
| BUTYLPHENYL)-) | |
| LINALOOL | 4.0000 |
| LINALYLACETAT | 1.5000 |
| MANDARINENALDEHYD 10% in TEC (DODECENAL, 2E-) | 0.5000 |
| ORANGE OIL | 1.5000 |
| POLYSANTOL ® (PENTEN-2-OL, 3,3-DIMETHYL-5-(2,2,3- | 0.5000 |
| TRIMETHYL-3-CYCLOPENTENYL)-4-) | |
| TERPINEOL | 0.5000 |
| TOCOPHEROL | 0.0500 |
| YSAMBER ® K (ISOLONGIFOLANONETHANDIOLKETAL) | 1.0000 |
| Total | 100.0000 |

### Example 6: Liquid Detergent

Water is heated to approx. 70° C. while being stirred. Ingredients 2 and 3 are added and dissolved in the order listed and stirred for 30 minutes without further heating. One after the other ingredients in the listed order are added and dissolved subsequently and not before the previous ingredient was dissolved. The pH value is adjusted to 9 with citric acid.

TABLE 8
Liquid detergent

| Ingredient | | INCI | Wt.-% |
|---|---|---|---|
| 1 | Wasser, demin. | Water | 47.7000 |
| 2 | Edenor K 12-18 | Cocos fatty acids | 3.0000 |
| 3 | Natrium Hydroxid 50% Losung | Sodium Hydroxide | 2.5000 |
| 4 | Novethix L-10 Polymer | NRC Nordmann, Rassmann | 2.5000 |
| 5 | Zetesol NL-2 | Sodium Laureth Sulfate | 30.0000 |
| 6 | Hoesch AE 50 | sodium Dodecylbenzenesulfonate | 3.0000 |
| 7 | Dehydol LT 7 | | 3.0000 |
| 8 | Hoesch Phos DET 32 D | Diethylenetriamine Pentamethylene Phosphonic | 1.0000 |
| | | acid Sodium salt | |
| 9 | Ethanol 96% | Ethanol | 2.0000 |
| 10 | Propylenglykol 1,2 | Propan-1,2-diol | 2.0000 |
| 11 | Trinatriumcitrat Dihydrat | Tri-sodiumcitrate-dihydrate | 2.0000 |
| 12 | Perfume composition B Example 4 | Perfume | 0.5000 |
| 13 | Jasmol | 2-Benzylheptanol | 0.5000 |
| 14 | BHT | 3,5-Di-tert-butyl-4-hydroxytoluene | 0.1000 |
| 15 | Parmatol A 26 | Mixture of 5-Chloro-2-methyl-2H-isothiazol-3-one | 0.2000 |
| | | and 2-Methyl-2H-isothiazol-3-one | |

| | |
|---|---|
| Total | 100.0000 |

### Example 7: Heavy Duty Liquid Detergent

TABLE 9
Heavy duty liquid detergent

| material | | INCI | wt.-% |
|---|---|---|---|
| 1 | Water | Water | 39.1000 |
| 2 | Tinopal CBS-X | Disodium Distyrylbiphenyl Disulfonate | 0.1000 |
| 3 | Edenor K 12-18 | Cocos fatty acids | 7.5000 |
| 4 | Kalium Hydroxid 50% solution | Potassium Hydroxide | 4.3000 |
| 5 | Propylenglykol 1,2 | Propan-1,2-diol | 5.0000 |
| 6 | Hoesch T 9 90% | Trideceth-9 | 12.0000 |
| 7 | Parmatol A 26 | Mixture of 5-Chloro-2-methyl-2H- | 0.2000 |
| | | isothiazol-3-one and 2-Methyl-2H- | |
| | | isothiazol-3-one | |
| 8 | Hoesch NAS 60 | Sulfonic acid, C 13-17-sec-Alkyl-, | 17.0000 |
| | | Sodium salt | |
| 9 | Triethanolamin pure C | Triethanolamine | 2.0000 |
| 10 | Trinatriumcitrat Dihydrat | Tri-sodiumcitrate-dihydrate | 5.0000 |
| 11 | Hoesch Phos DET 32 D | Diethylenetriamine Pentamethylene | 3.0000 |
| | | Phosphonic acid Sodium salt | |
| 12 | Ethanol 96% | Ethanol | 3.0000 |
| 13 | Alcalase 2,5 L | Protease | 0.4000 |
| 14 | Termamyl 300 L | Alpha-Amylase | 0.3000 |
| 15 | perfume composition A example 3 | perfume | 0.5000 |
| 16 | Jasmol | 2-Benzylheptanol | 0.5000 |
| 17 | BHT | 3,5-Di-tert-butyl-4-hydroxytoluene | 0.1000 |

| | |
|---|---|
| Total | 100.0000 |

Ingredients 1 and 2 are mixed and heated up to 50° C. Ingredients 3 and 4 are added and it is stirred until soap has formed. Ingredients 5 to 10 are added in the given order and it is cooled down to 30° C. Ingredients 11 to 14 are added in the given order and the pH is adjusted to 8.5, if necessary. Subsequently, ingredients 15 to 17 are added.

### Example 8: Powder Detergent

TABLE 10
Powder detergent

| Ingredient | INCI | Wt.-% |
|---|---|---|
| Sodium Metasilicate Pentahydrate | Sodium Metasilicate Pentahydrate | 47.200 |
| Sodium Hydrogen Carbonate | Sodium Hydrogen Carbonate | 15.000 |
| Sodium carbonate peroxyhydrate | Sodium carbonate peroxyhydrate | 15.000 |
| Peractive AC Blue | TAED/Na-Carboxymethylcellulose | 5.000 |
| Genapol OA-080 | Oxoalkohol C14-15, 8 EO | 3.000 |
| Texapon K12 Powder | Sodium Lauryl Sulphate C12 | 7.000 |
| Tinopal CBS-X | Benzenesulfonic acid, 2,2′-([1,1′-bi- | 0.500 |
| | phenyl]-4,4′-diyldi-2,1-ethenediyl)bis-, | |
| | disodium salt | |
| Savinase 6.0 T, Type W | Protease | 0.400 |
| Termamyl 120 T | Alpha-Amylase | 0.300 |
| Sodium Sulphate | Sodium Sulphate | 5.000 |
| BHT | 3,5-Di-tert-butyl-4-hydroxytoluene | 0.100 |
| Jasmol | 2-Benzylheptanol | 0.500 |
| Perfume composition C example 5 | Perfume | 1.000 |
| | Total | 100.000 |

### Example 9: Detergent Bar

TABLE 11
Detergent Bar

| Ingredient | INCI | Wt.-% |
|---|---|---|
| Britesil H 20 | Sodium Silicate | 14.6500 |
| Dolomite | Sudesan | 25.0000 |
| Grundseife HTS | Sodium Tallowate, Sodium Cocoate, | 43.6500 |
| | sodium Palm Kernelate | |
| Marlon ARL | C-10-13, ABS-Na, Pulver | 6.7000 |
| Texapon Z HK Pulver | Sodium fatty alcohol C12-C18 | 6.6000 |
| Titanium Dioxid | Titanium Dioxide | 1.0000 |
| Kosmfst. Säureblau 7, C.I.42080 | | 0.2000 |
| Powder | | |
| Perfume composition A Example 3 | Perfume | 1.0000 |
| Jasmol | 2-Benzylheptanol | 1.0000 |
| BHT | 3,5-Di-tert-butyl-4-hydroxytoluene | 0.2000 |
| | Total | 100.0000 |

The perfume composition A (Example 3), Jasmol and BHT are mixed. All further ingredients are homogenized with a kneader. The mixture of perfume composition A (Example 3), Jasmol and BHT is added and homogenized as well. Finally, a soap bar is formed by an extruder.

### Example 10: Fabric Softener

TABLE 12
Fabric Softener

| Ingredient | INCI | Wt.-% |
|---|---|---|
| Water demin. | Aqua | 70.800 |
| Rewoquat WE 18 | Dialkylesterammonium-ethosulfate | 16.600 |
| Mergal K9N | 5-Chloro-2-methyl-3-(2H)-isothiazolone | 0.100 |
| | and 2-Methyl-3-(2H)-isothiaolone | |
| Dow Corning 1520 antifoam | Polydimethylsiloxane | 0.300 |
| Magnesium chloride 1% solution | Magnesium chloride solution | 10.000 |
| Perfume composition A example 3 | perfume | 1.000 |
| Jasmol | 2-Benzylheptanol | 1.000 |
| BHT | 3,5-Di-tert-butyl-4-hydroxytoluene | 0.200 |
| | Total | 100.000 |

1. A composition for reducing malodor comprising:
(a) one or more compound(s) of formula (I) (2-benzylheptanol) 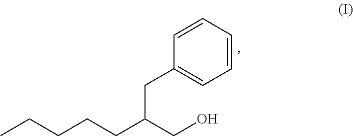
and
(b) one or more compound(s) selected from the group consisting of compound(s) of formula (II) (3,5-di-tert-butyl-4-hydroxytoluol, BHT), compound(s) of formula (III) (octadecyl di-tert-butyl-4-hydroxy-hydrocinnamate) and compound(s) of formula (IV) (pentaerythrityl tetra-di-tert-butyl hydroxyhydrocinnamate) 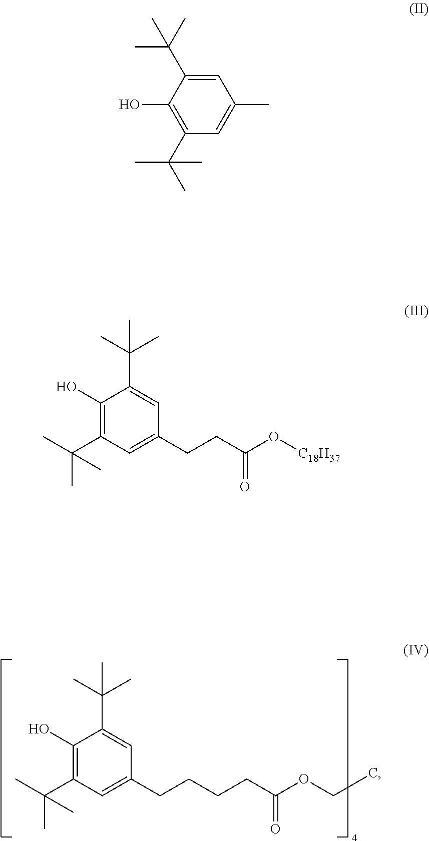
(c) optionally, one or more solvent(s) selected from the group consisting of water, ethanol, dipropylene glycol (DPG), diethyl phtalate (DEP), dimethyl phtalate (DMP), propylene glycol (PG), isopropyl myristate (IPM), isopropyl palmitate (IPP), triethyl citrate (TEC), triacetin (TRI), 1,2-propanediol, 1,3-propanediol, propanetriol, pentanediol, hexanediol, octanediol, decanediol, dodecanol, 4-hydroxyacetophenone, glycerine, butylene glycol, pentylene glycol, hexylene glycol, decylene glycol, propylene carbonate, butylene carbonate, glycerine carbonate, 2-benzyl heptanol, lauryl alcohol, trimethyl hydroxypentyl isobutyrate, glyceryl caprylate, ethylhexylglycerine, benzyl benzoate (BB), isoparaffinic hydrocarbons having a distillation range of 191-211° C., isoparaffinic hydrocarbons having a distillation range of 207-253° C., dipropylene glycol methylether, tripropylene glycol methylether, dioctyl adipate, hexylene glycol, isopropyl alcohol and isooctanone,
(d) optionally, one or more substances selected from the group consisting of extracts from natural materials; amyris oil; angelica seed oil; angelica root oil; anise seed oil; valerian oil; basil oil; woodmoss absolue; bay oil; mugwort oil; benzoe resin; bergamot oil; bees wax absolue; birch tar oil; bitter almond oil; savory oil; bucco leaf oil; cabreuva oil; cade oil; calmus oil; campher oil; cananga oil; cardamomen oil; cascarilla oil; cassia oil; cassie absolue; castoreum absolue; cedar leaf oil; cedar wood oil; cistus oil; citronella oil; citrus oil; copaiva balsam; copaiva balsam oil; coriander oil; costus root oil; cumin oil; cypre oil; davana oil; dill herb oil; dill seed oil; Eau de brouts absolue; oakmoss absolue; elemi oil; estragon oil; eucalyptus-citriodora oil; eucalyptus oil; fennell oil; pine needle oil; galbanum oil; galbanum resin; geranium oil; grapefruit oil; guajak wood oil; gurjun balsam; gurjun balsam oil; helichrysum absolue; helichrysum oil; ginger oil; orris root absolue; orris root oil; jasmin absolue; kalmus oil; camilla oil blue; camilla oil; carrot seed oil; cascarilla oil; peppermint oil; caraway oil; labdanum oil; labdanum absolue; labdanum resin; lavandin absolue; lavandin oil; lavender absolue; lavender oil; lemongras oil; lovage oil; limette oil linaloe oil; litsea-cubeba oil; bay leaf oil; macis oil; marjoram oil; mandarin oil; massoi bark oil; mimosa absolue; musk kernel oil; musk tincture; muskatella-sage oil; nutmeg oil; myrrh absolue; myrrh oil; myrtal oil; carnation leaf oil; carnation flower oil; neroli oil; olibanum absolue; olibanum oil; opopanax oil; orange flower absolue; orangen oil; origanum oil; palmarosa oil; patchouli oil; perilla oil; perubalsam oil; parsley leaf oil; parsley seed oil; petitgrain oil; wintergreen oil; pepper oil; piment oil; poley oil; rose absolue; rose wood oil; rose oil; rosmary oil; sage oil; sandal wood oil; celery seed oil; spik lavender oil; star anise seed oil; styrax oil; tagetes oil; tea-tree oil; turpentine oil; thyme oil; tolu balsam; tonka absolue; tuberose absolue; vanilla extract; viole leaf absolue; verbena oil; vetiver oil; juniper berry oil; wine yeast oil; wormwood oil; ylang ylang oil; ysop oil; civet absolue; cinnamon leaf oil; cinnamon bark oil as well as fractions thereof or ingredients isolated thereof; 3 carene; pinene; terpinene; p-cymol; bisabolen; camphene; caryophyllene; cedrene; farnesene; limonene; longifolene; myrcene; ocimene; valencene; (E,Z)-1,3,5-undecatriene; styrol; diphenylmethane; aliphatic alcohols; aliphatic aldehydes and their acetales; aliphatic ketones and their oximes; aliphatic sulfur containing substances; esters of aliphatic carbonic acids; acyclic terpene alcohols; acyclic terpene aldehydes and ketones; cyclic terpene alcohols; cyclic terpene aldehydes and ketones; cyclic alcohols; cycloaliphatic alcohols; cyclic and cycloaliphatic ether; cyclic and macrocyclic ketones; cycloaliphatic aldehydes; cycloaliphatic ketones; esters of cyclic alcohols; esters of cycloaliphatic alcohols; araliphatic alcohols; ester of araliphatic alcohols and aliphatic carbonic acids; araliphatic ether; aromatic and araliphatic aldehyde; aromatic and araliphatic carbonic acids and their esters; nitrogen containing aromatic substances; phenylesters; and heterocyclic substances,
wherein the total amount of compound(s) of group (a) in the composition is 0.05 to 10 wt.-%,
the total amount of compound(s) of group (b) in the composition is 0.0001 to 1 wt.-%,
the total amount of compound(s) of group (c), if present, in the composition is 0.000001 to 99.9 wt.-%,
the total amount of substance(s) of group (d), if present, in the composition is 0.000001 to 99.9 wt.-%,
in each case based on the total weight of the composition.

2. The composition according to claim 1, wherein the composition is a liquid or a solid under standard conditions.

3. The composition according to claim 1 comprising water in a total amount of 0.0000001 to 90 wt.-%, based on the total weight of the composition.

4. A method for producing a composition according to claim 1 comprising:
(i) providing compounds of (a) and (b),
(ii) optionally, providing compound(s) of (c),
(iii) optionally providing substance(s) of (d), and
(iv) mixing compounds of (a) and (b) and, if applicable, of (c) and/or substance(s) of (d).

5. A method for producing a composition according to claim 3 comprising:
(i) providing compounds of (a) and (b),
(ii) providing compound(s) of group (c), wherein the or one of the solvent(s) is water, and wherein the water is provided in a total amount of 0.0000001 to 50 wt.-%, based on the total weight of the composition,
(iii) optionally providing substance(s) of (d), and
(iv) mixing compounds of group (a), (b) and (c) and, if applicable, substance(s of (d).

6. (canceled)

7. A preparation comprising:
(a) a composition according to claim 1, and
(b) one or more surface active compound(s) selected from the group consisting of alkyl carboxylate, alkyl sulfonate, alkyl sulphate, alcohol polyglycol ether sulfate, quarternary ammonium cations, quarternary ammonium ester, alcohol polyglycol ether, N-(acylaminoalkyl)-betaine, polyethylene glycol alkyl ether, alkyl benzene sulfonate, and TEA-esterquat.

8. A preparation according to claim 7, wherein the preparation is a laundry care product.

9. A preparation according to claim 7, wherein the total amount of the composition according to claim 1 in the preparation is sufficient to provide an anti-malodor effect.

10. A preparation according to claim 7, wherein the weight ratio of the total amount of the composition in the preparation to the total amount of surface active compound(s) in the preparation is in the range of 1:1600 to 10:1.

11. (canceled)

12. A method for producing a preparation according to claim 7, comprising:
(i) providing the composition of (a);
(ii) providing the one or more surface active compound(s) of (b); and
(iii) mixing (i) and (ii).

13. (canceled)

14. (canceled)

15. The composition according to claim 1, wherein the total amount of compound(s) of group (a) in the composition is 0.1 to 1 wt.-%,
the total amount of compound(s) of group (b) in the composition is 0.01 to 0.1%,
the total amount of compound(s) of group (c), if present, in the composition is 0.0001 to 99.9 wt.-%, and
the total amount of substance(s) of group (d), if present, in the composition is 0.0001 to 95 wt.-%,
in each case based on the total weight of the composition.

16. The preparation according to claim 7, wherein the total amount of the composition in the preparation is 0.05 to 10 wt.-%, based on the total weight of the preparation.

17. The preparation according to claim 7, wherein the total amount of the composition in the preparation is 0.1 to 1 wt.-%, based on the total weight of the preparation.

18. The preparation according to claim 7, wherein the laundry care product is selected from the group consisting of liquid detergent, heavy duty liquid detergent, high-pH liquid detergent, powder detergent, heavy duty powder detergent, detergent bar, fabric softener, fabric softener concentrate, water softener powder, water softener tab, water softener gel, bleach, spot remover, laundry hygiene, and pre-wash detergent.

19. A method for reducing malodor in fabric, clothes, and/or laundry comprising adding a composition according to claim 1 to the fabric, clothes, and/or laundry and reducing the malodor.

20. The method according to claim 19, wherein the malodor is a musty and/or moldy malodor.

21. The method according to claim 19, wherein the composition is added to the laundry and the laundry washed at a temperature of 60° C. or less.

22. The method for reducing malodor in fabric, clothes, and/or laundry comprising adding a preparation according to claim 10 to the fabric, clothes, and/or laundry and reducing the malodor.

23. The method according to claim 22, wherein the malodor is a musty and/or moldy malodor.

24. The method according to claim 22, wherein the preparation is added to the laundry and the laundry washed at a temperature of 60° C. or less.
